(19) United States
(12) Patent Application Publication
(10) Pub. No.: US 2025/0378472 A1
(43) Pub. Date: Dec. 11, 2025

(54) LARGE LANGUAGE MODEL OPERATIONS

(71) Applicant: Kraftful Inc., San Francisco, CA (US)

(72) Inventor: Yana Welinder, San Francisco, CA (US)

(21) Appl. No.: 19/234,590

(22) Filed: Jun. 11, 2025

Related U.S. Application Data
(60) Provisional application No. 63/658,788, filed on Jun. 11, 2024.

(51) Int. Cl. G06Q 30/0282; G06N 3/082

(52) U.S. Cl. CPC G06Q 30/0282; G06N 3/082

(57) ABSTRACT

A large language model (LLM) can process customer or user feedback data and provide insights regarding how to improve a product or service. The LLM can be prone to hallucination, depending on how inputs are provided to the LLM and how the LLM is prompted. LLM hallucination can be reduced by constraining the size of the input and by prompting the LLM with specific prompts, including instructions to force the LLM to recite a location or source of input data, from which the LLM generates an output.

### CROSS-REFERENCE TO RELATED APPLICATIONS

This application claims the benefit of priority of U.S. Provisional Application No. 63/658,788, filed on Jun. 11, 2024, titled “HALLUCINATION DETECTION,” the content of which is incorporated herein by reference in its entirety and should be considered a part of this specification.

### BACKGROUND

### Field

This invention relates generally to the field of artificial intelligence, and more particularly to configuring artificial intelligence models to produce more accurate results.

### Description of the Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Large language models (LLMs) have revolutionized the modern business environment and have proved useful in many applications. Nevertheless, use of LLM technology has not been without challenges. For example, LLMs, for certain combinations of input data and prompts, can tend to hallucinate. LLM hallucination can include the LLM producing an inaccurate output in the context of a given prompt, for example, by misrepresenting or inaccurately representing the input data for a summary prompt, or outputting text, in response to a summary prompt, which does not exist in the input data. Consequently, there is a need for more robust LLM technology and use techniques to reduce LLM hallucination, and improve the accuracy of the output of the LLMs.

### SUMMARY

The appended claims may serve as a summary of this application. Further areas of applicability of the present disclosure will become apparent from the detailed description, the claims, and the drawings. The detailed description and specific examples are intended for illustration only and are not intended to limit the scope of the disclosure.

### BRIEF DESCRIPTION OF THE DRAWINGS

These drawings and the associated description herein are provided to illustrate specific embodiments of the invention and are not intended to be limiting.

FIG. 1 illustrates an LLM-based pipeline, according to an embodiment.

FIG. 2 illustrates a block diagram of the operations of an insight extraction stage for a selection of feedback data.

FIG. 3 illustrates a block diagram of the operations of a primary grouping layer.

FIG. 4 illustrates a diagram of the operations of a preliminary grouping layer or layers when the number of insight summaries exceed an LLM input size threshold parameter.

FIG. 5 illustrates a diagram of a mapping stage.

FIG. 6 illustrates an environment in which some embodiments may operate.

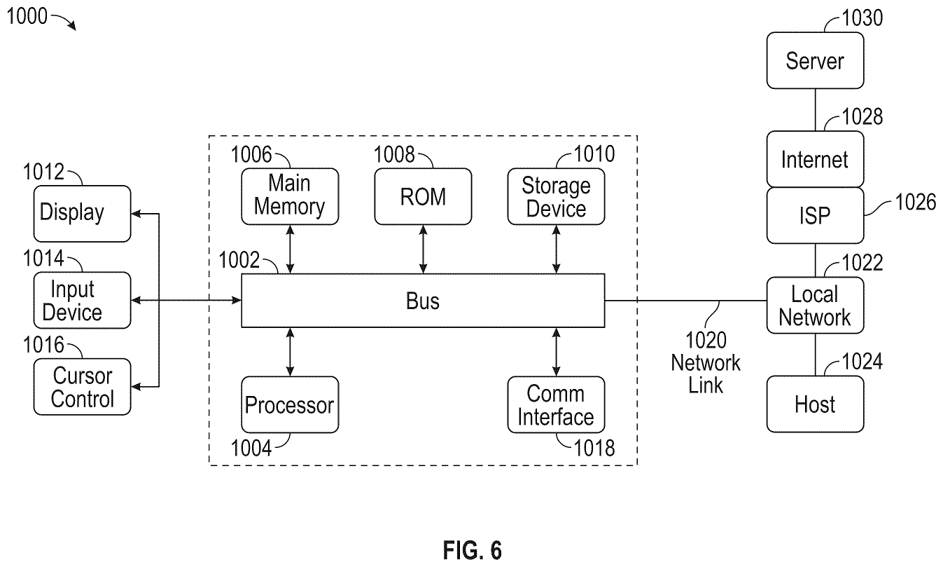

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements. Some of the embodiments or their aspects are illustrated in the drawings.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

According to various embodiments, a query for a portion of a type of content can be an input to a large language model (LLM). Example types of content can include: online user reviews/comments, user survey responses, customer support tickets, call transcripts from user interviews or sales calls, and additional sources of content that may be of interest to a product or service provider.

A large language model (LLM) extracts points from each content portion. A content portion (of any type) may be referred to herein as a comment. For example, a first query for a first comment is input to the LLM, which can extract a first point (e.g., a first type of insight). A second query for a second comment may be input to the LLM, which can extract a second point (e.g., a second type of insight), and so forth. Some example insights (e.g., points) that may be extracted from a comment by the LLM in response to a query can include: a complaint insight, a product feature request insight, a popular product feature identification insight, a competitor mention insight (e.g., competing product or company), frequently mentioned product feature insight, a pain point insight, a key product takeaway insight, a bug report insight, a usability insight, a product pricing insight, a support satisfaction insight, strength insight for a Strengths, Weaknesses, Opportunities, Threats (“SWOT”) analysis, a weakness insight for a SWOT analysis, an opportunity insight for a SWOT analysis, a threat insight for a SWOT analysis, a ‘says’ insight for an empathy map analysis, a ‘does’ insight for an empathy map analysis, a ‘thinks’ insight for an empathy map analysis, a ‘feels’ insight for an empathy map analysis, a ‘what is’ insight for a Four-Whats analysis, a ‘what wows’ insight for a Four-Whats analysis, a ‘what if’ insight for a Four-Whats analysis, and a ‘what works’ insight for a Four-Whats analysis.

In some embodiments, when extracting a point, the LLM can be prompted to provide a specific reference to the source of the insight (e.g., an exact row in a transcript of a customer service call), in which the insight was identified. Configuring the LLM to provide a source citation can reduce the likelihood of model hallucination, as well as establishing a verifiable record, which can manually or automatically (e.g., through a test script) can check that the LLM output has not been produced by AI hallucinations.

### Grouped Extracted Points

In various embodiments, the insights (e.g., points) extracted from comments may be organized according to type. For example, extracted points from multiple comments that are complaint insights can be stored together as one category of insights. Extracted points that are “feature request” insights can be stored together as a second category of insights, and so forth.

Each category of extracted points can be analyzed by an LLM via a prompt. In response to the prompt, the LLM can generate a new list of insights (e.g., grouped insights). To generate the new list, the LLM can group any similar extracted points into one grouped insight, so that each insight in the new list is unique.

The LLM can be prompted to provide references to the original points it grouped or rephrased when generating a new list. This requirement can increase the model accuracy during an analysis step and can maintain a record of original point references, thereby allowing for manual or automated checking that no hallucinations were introduced throughout the steps in the analysis process.

Prompts for grouped extracted points for the LLM can be managed according to a content size window(s). For example, the size of grouped extracted points for a particular insight type from a time range can be compared against a size threshold. For example, in some embodiments, a content size window may set a size maximum of 1,000,000 tokens, for grouped extracted points from a time range of 24 hours. Other time ranges can also be used. If the size maximum of a content size window is not exceeded, the LLM can analyze the grouped extracted points via a prompt and a summary list of insights is returned.

If the size maximum of a content size window is exceeded, in a first phase, the grouped extracted points are divided into subsets. Each subset is analyzed by the LLM via its own prompt. Each subset prompt may be the same. A respective further list of insights is returned in response to each subset prompt.

In a second phase, the further list of insights returned from the first phase are combined. If the combined lists of insights does not exceed the size maximum, the LLM can analyze the combined lists of insights via the same prompt of the first phase and a summary list of insights is returned.

If the combined list of insights exceeds the size maximum, a select amount of points (e.g., insights) from each list used for the combination list is saved for the next subset until a combination of trimmed lists does not exceed the size maximum.

In a third phase, the combination of trimmed lists is sent back to the LLM with the same prompt(s). A summary list of insights is returned by the LLM in response to the prompt for the combination of trimmed lists. Additional phases can continue, depending on the content size. Each phase can alternatively be referred to as a grouping step. In other words, the grouping steps can in multiples, depending on the size of the content.

At every grouping step, the LLM can be instructed to reference the original points it grouped or rephrased when generating a new list. The source citation can increase accuracy at each analysis step and can maintain a record of original points, checking and/or validating that hallucinations have not been introduced throughout the analysis process.

### Leveraging References to Check for Lack of Hallucination

A computer system can use the references in the output from each step to map each final insight back to the original snippets in the content where users mentioned the point in online reviews/comments, survey responses, customer support tickets, and call transcripts. This mapping enables manual or automatic validation to check whether hallucinations were introduced during any of the analysis steps. Any hallucinations detected through the process can be traced back to the specific step where they occurred, allowing refinement of the LLM prompts at the affected steps to prevent future hallucinations. In particular, embodiments where the LLM prompts include an LLM instruction to record a source of the output of the LLM provide an avenue for manual or automatic checking of the output of the LLM. For example, when the LLM presents an output along with a source identifier of the input from which the LLM generated the output, a manual or automated check can be performed to determine whether the output matches the LLM-stated source. LLM hallucinations present as mismatched output and LLM-stated source. For example, for a summary prompt, when the LLM states a source in the input, the LLM-generated summary prompt can be compared against the source data. Furthermore, as some usages of the LLM include applying the LLM in several layers where the input in some stages depend on the output from a previous stage, forcing the LLM to recite a source of its output in its input data allows for identifying hallucination in complex nested and layered applications of the LLM.

### Improving the Accuracy of LLM Technology by Reducing LLM Hallucination

Large language models can receive a body of text as input and can provide an analysis of the text in various formats. For example, LLMs can provide a summary of the text or provide key ideas introduced or discussed in the text. The analysis and the output of the LLM is typically driven by a prompt to the LLM. The prompt configures and instructs the LLM to analyze the text under the constraints and specifications outlined in the prompt. The LLMs, while powerful tools, are not immune from inaccuracies. In particular, LLMs can be susceptible to hallucination. Hallucination, in this context, can refer to situations where a large language model, in response to a prompt outputs an analysis of the text that is not at all mentioned in the input text or be an inaccurate paraphrase of a portion of the text. Hallucination, obviously, reduces the usefulness and reliability of the LLMs. The more voluminous a model's input text and the less specific the prompt, the more likely that the model can hallucinate. For example, working under an abstract prompt constraint and having to analyze a large body of text under the abstract prompt constraint, an LLM can produce outputs that are not really supported by the input or are an inaccurate misrepresentation of a portion of the input text. If these limitations are addressed, the LLMs can provide a powerful tool to modern businesses.

In particular, modern businesses have substantial and voluminous sources of customer or client feedback content, which can provide excellent insight into improving their existing products and innovating in their respective industries. The LLMs in this context can also be a powerful tool to the modern product development team. Existing approaches to utilizing LLM for the purpose of extracting insight for product and/or service development includes inputting into an LLM, a large body of text directed to the product and service and instructing the LLM to summarize the large body of the information. Some existing approaches use embeddings to synthesize a searchable index, against which comments can be and are analyzed in bulk. In other words, existing approaches utilize bulk processing of user feedback to produce product insight. As discussed earlier, the increased volume of input to LLMs, coupled with an abstract prompt, such as (“summarize this body of user feedback to get insights that may be of interest to a product developer”) can cause the LLM to hallucinate. Consequently, there is a need for LLM-based product development approaches that can configure and instruct non-deterministic LLMs to behave in a predictable and repeatable manner.

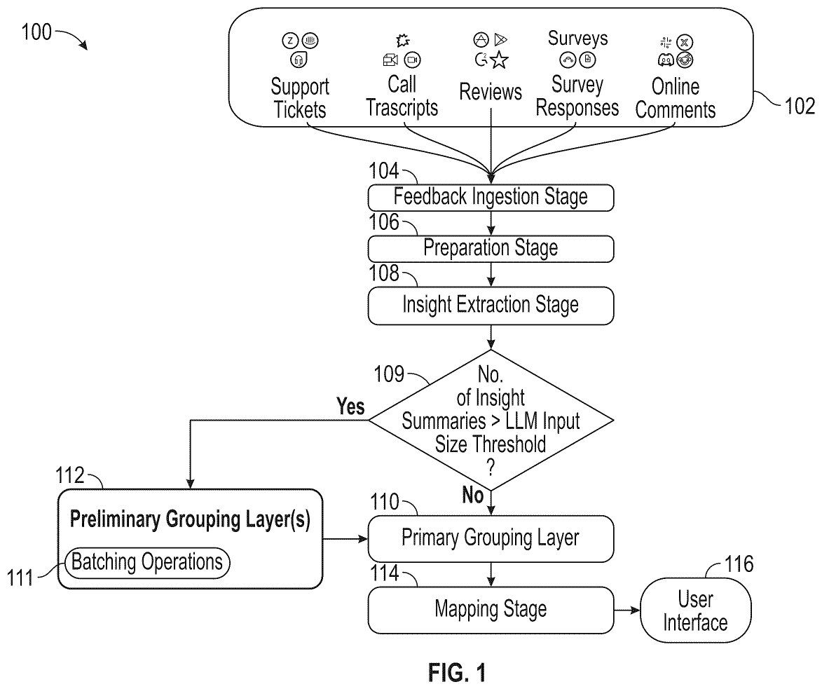

FIG. 1 illustrates an LLM-based pipeline 100, according to an embodiment. The pipeline 100 receives customer feedback from a variety of feedback sources 102 and generates insights that may be of interest to a product or service development team. Example feedback sources 102 can include support tickets, customer call transcripts, reviews (e.g., online reviews), survey responses, and online user comments directed to a product or service. The pipeline 100 can include a feedback ingestion stage 104. Feedback ingestion stage 104 can include operations to allow a user of the pipeline 100 registering a product or service with the provider of the pipeline 100, and the provider of the pipeline 100 configuring an integration platform to interface with the feedback sources 102. The integration platform can track the feedback sources 102, in relation to a registered product or service. In some embodiments, the integration platform can collect data from the feedback sources 102 on a regularly scheduled selected interval (e.g., daily, weekly, etc.). The integration platform can include application programming interfaces or APIs, provided by the feedback sources 102 or built by the provider of the pipeline 100, with which the integration platform can obtain feedback data from the feedback sources 102.

The pipeline 100 can include a preparation stage 106. Depending on the feedback data and the feedback source 102, the received feedback data can be formatted, reformatted or converted into structured data suitable for pipeline 100 operations. In other words, the preparation stage 106 can structure or restructure the raw feedback data received from the feedback sources 102. The structuring of the feedback data is performed to provide the LLMs increased (e.g., maximal) context regarding the feedback data. For example, support tickets feedback data can be received via an API as separate comments. Structuring the data in this scenario can include generating a table of support tickets feedback data with author, timestamp, and other metadata. Preparation stage 106 can also include adding identifiers (e.g., numerical identifiers) to select portions of the feedback data to allow the LLMs an efficient and effective method of recording a reference back to the location in the feedback data, from which an insight was generated. The preparation stage 106 operations can also include removing noise, where noise is determined based on the nature and characteristics of the feedback data. For example, in the context of emails removing noise can include removing forwarded emails text when they appear below an email signature line. Preparation stage 106 operations can also include deduplicating the feedback data, or removing repetition from the feedback data.

The pipeline 100 can include an insight extraction stage 108. The insight extraction stage operations include receiving the prepared feedback data from the preparation stage 106 and extracting one or more insights from feedback data. A more comprehensive example list of insights are listed above. Example insights can include a “complaint insight,” a “feature request” insight, a “customer pain point” insight, and many more. Insight extraction stage 108 operations can include providing a portion of the feedback data to an LLM. Providing only a portion of the feedback data, as opposed to providing a bulk input to the LLM, can improve the performance of the LLM, by for example, reducing the likelihood of hallucination. The size of the portion of the feedback data can depend on the type and nature of the feedback data and the type of insight. The portion of feedback data can, in part, be selected to maintain a reliable context for the LLM to perform its function reliably. For example, in the case of customer service, or call center transcripts, the portion of the feedback data can be chosen to be a full transcript of a single customer call, and not to provide any additional transcript inputs to the LLM. In this manner, the LLM can have the full transcript and the context of the conversation therein to extract an insight. In this example, having a smaller unit of input to the LLM can cause the LLM to lose the context that can improve insight extraction. The term “extraction” does not imply that the insight may be expressly stated in the portion of the feedback. The insight may be expressly or impliedly be included in a portion of the feedback data. In some embodiments, the feedback data can include user comments.

The insight extraction stage 108 operations can include issuing an insight extraction prompt to the LLM to determine whether the portion of feedback data can be a match to an insight. For example, the portion of feedback data can be user comments in a transcript of a customer service call. The insight extraction prompt can include an instruction, which in part asks the LLM to determine whether the transcript includes a “feature request.” To reduce the likelihood of LLM hallucination, the insight extraction prompt can be as specific as possible. For example, instead of instructing the LLM to “extract insights relevant to a product designer,” the LLM can be instructed to “determine whether the portion of the feedback data, specifically, includes a ‘feature request’ insight.” In other words, to improve the performance of the LLM, in this context, the size of the input data can be reduced and the prompt can be made more specific. Consequently, with this approach, the insight extraction stage 108 can include operations that selects portions of the feedback data, to reduce the size of the input, while maintaining the context of the insights in the input data, and prompting the LLM with more specific instructions for insight extraction (e.g., instructing the LLM with a single insight, and re-prompting the LLM for additional insights, every time with a single insight extraction instruction).

The insight extraction stage 108 operations further includes an instruction to the LLM to generate an insight summary of the extracted insight as well as to record an identifier (ID) of a location in the feedback data (or the portion of the feedback data that was the input to the LLM) from which the LLM extracted the insight and/or generated the summary. In other words, the LLM can be instructed to generate its insight summary output by reciting an identifier of a location of the portion of the feedback data, from which the LLM extracted the insight and generated the insights summary. For example, in the context of call transcripts, the LLM can generate and output a “feature request” insight summary, plus an identifier of the row in a transcript, from which the LLM determined and/or extracted the insight summary. Insight extraction prompt can include additional LLM instructions, depending on the nature and characteristics of feedback data. For example, in the context of call transcripts, the insight extraction prompt can include an LLM instruction to determine which sentences in the transcript are likely from a customer, and which sentences are likely from a customer service representative.

The pipeline 100 includes a primary grouping layer 110, where the insight summaries from the insight extraction stage 108 are input to an LLM with a grouping prompt. Similar to insight extraction stage 108, the input to the LLM is provided in a size selected to reduce LLM hallucination. In some embodiments, the number of the insight summaries used as input to the LLM in the primary grouping layer 110 is determined based on a content window size parameter of the LLM. The content window size of an LLM can be expressed in units of “token.” Token in the context of LLMs refers to the fundamental unit of text that the LLM can process. Content window size can refer to the maximum number of tokens the LLM can reliably analyze for one set of input data and for one prompt. For example, some LLMs may have a content window size of 1,000,000 tokens. The number of insight summaries grouped at the primary grouping layer 110 can be selected based on the content window size of the LLM. In some embodiments, an LLM input size threshold can be selected. The LLM input size threshold is less than the content window size, and is selected to reduce LLM hallucination. In some embodiments, the LLM input size threshold can be empirically selected. In other words, the provider and/or the user of the pipeline 100 can choose not to use the maximum input bandwidth of the LLM, and instead use a smaller input size (e.g., equal to the LLM input size threshold parameter set by the provider and/or the user) to further reduce the likelihood of LLM hallucination.

The grouping prompt instructs the LLM to collate the similar insight summaries and to generate a primary layer grouped insight summary for each group. The primary layer grouped insight summaries are distinct or unique relative to one another. The grouping prompt can include an instruction to the LLM to generate the primary layer grouped insight summaries in a manner that each primary layer grouped insight summary is distinct or unique, relative to the other primary layer grouped insight summaries. The same constraints that were applied in the insight extraction stage 108, for example the instruction to constrain the size of the input and the instruction to recite a source of the LLM output, can also be applied in the primary grouping layer 110 in order to reduce LLM hallucination. The input to the LLM in the primary grouping layer 110 includes the insight summaries from the insight extraction stage 108. The number of insight summaries can be constrained and reduced, relative to the LLM content window size. In some embodiments, the number of insight summaries input to the LLM in the primary grouping layer 110 can be selected to be equal to the content window size. In other embodiments, a number of insight summaries fewer than the content window size can be selected. The input size of the LLM in the primary grouping layer 110 can also be empirically determined. In some implementations, the number of input insight summaries in the primary layer is less than or equal to the LLM input size threshold.

The grouping prompt can include LLM instructions to recite, record or state the identifiers of the insight summaries from which a primary layer grouped insight summary was generated. In other words, the LLM in the primary grouping layer 110 is constrained in its output to only those primary layer grouped insight summaries for which the LLM can recite a collection or a group of insight summaries from the insight extraction stage 108.

When the number of the insight summaries from the insight extraction stage 108 exceeds the content window size of the LLM, and/or when a number of insight summaries exceed the LLM input size threshold, the insight summaries can be divided into batches smaller in size than the content window size or LLM input size threshold, and each batch of insight summaries can be processed through one or more preliminary grouping layers 112, where each grouping layer progressively reduces the size of the input in each layer's respective output, generating more concise insight summaries, relative to its prior layers, until the number of insight summaries reach below the LLM input size threshold. In this scenario, the pipeline 100 can include batching operations 111 and preliminary grouping layers 112. The pipeline 100 can include a decision step 109, where if the number of insight summaries from the extraction stage exceeds the LLM input size threshold, one or more preliminary grouping layers 112 progressively reduce the input size until the number of insight summaries reach equal or less than the LLM input size threshold. When the number of insight summaries from the extraction stage do not exceed the LLM input size threshold (decision step 109=No), the operations of the preliminary grouping layers 112 are not triggered. The preliminary grouping layers 112 can alternatively be referred to as the intermediary grouping layers.

The operations of the preliminary grouping layers 112 can be triggered when the size of the output of a previous layer (e.g., the insight extraction stage 108), exceeds the LLM window content size, and/or the LLM input size threshold. In this scenario, the input to the LLM can be divided or batched in sizes equal or smaller than the LLM input size threshold. The grouping prompt in each layer and for each batch can stay the same to maintain a consistent analysis of LLM for each input batch. To reduce LLM hallucinations, grouping prompts for each batch can include an LLM instruction to recite the identifiers of the insight summaries from which a grouped insight summary is generated.

The pipeline 100 can include a mapping stage 114. The mapping stage 114 utilizes the recordation of the source identifiers to construct a data structure and a user interface map of the chain of insight summaries, from the primary grouping layer to preliminary grouping layers and to the portion of the selection of the feedback data, from which a primary insight summary was generated. The pipeline 100 can present the map of insight summaries in one or more user interface elements of a user interface 116. The user interface 116 can include a dashboard, where the user can click on an insight summary and view the portion of the selection of feedback data from which a primary insight summary was generated. The preliminary and/or intermediary insight summaries may or may not be shown, or available to the user for inspection via the dashboard.

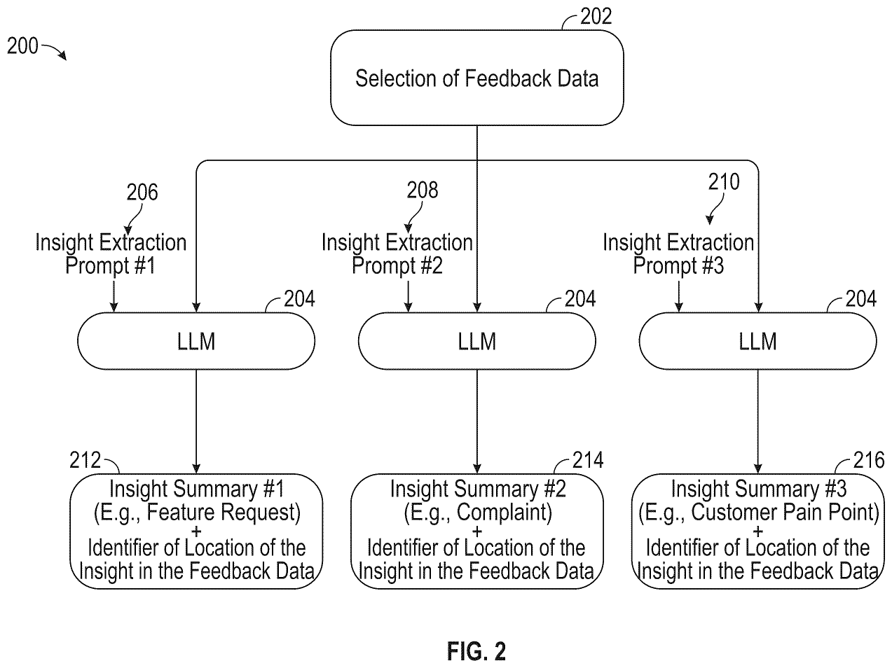

FIG. 2 illustrates a block diagram 200 of the operations of the insight extraction stage 108 for a selection of feedback data 202. The operations illustrated in diagram 200 can be repeated for additional selections of feedback data 202. For example, in the case of customer service transcripts, the feedback data collected for a time period can include hundreds of transcripts. The selection of feedback data 202, in this scenario, can be chosen to be a single transcript. This selection reduces the size of the input, which can reduce the likelihood of LLM hallucination, while preserving increased context for LLM to determine whether the transcript contains portions that match an insight. The operations illustrated in diagram 200 can be repeated for each transcript in the feedback data. The selection of feedback data is provided as input to an LLM 204 one or more times, each with an insight extraction prompt directed to a different insight. For example, the LLM 204 can be run with insight extraction prompt 206, directed to “feature request” insight. The LLM 204 can be run with another insight extraction prompt 208, directed to “complaint” insight. The LLM 204 can be run with insight extraction prompt 210, directed to “customer pain point.” The LLM 204 can be run with additional insight extraction prompts. Not every execution of the LLM 204 with an insight extraction prompt necessarily yields a match with an insight, if for example, the selection of feedback data 202 does not contain the insight.

The LLM 204, in the insight extraction stage 108, can be run with a prompt, directed to a distinct insight. Furthermore, the insight extraction prompts contain LLM instructions to record an identifier of the location of an extracted insight in the selection of feedback data 202. In the case of transcripts for example, the identifier of the location can include a transcript identifier and a transcript row from which the LLM extracted the insight. The format and characteristics of the location identifier can depend on the type and characteristics of the feedback data and can differ for different types of feedback data. The insight extraction prompts also contain LLM instructions to summarize the extracted insights and to generate an insight summary as part of the output. In the example shown in diagram 200, three runs of the LLM 204 with three different insight extraction prompts have yielded insight extraction outputs 212, 214, and 216. In this example, the insight extraction results include insight summaries directed to an insight type, for example “feature request,” “complaint,” and “customer pain point,” as well as location identifiers from which the LLM 204 extracted these insight types. The insight summaries can be collected in a table of insight summaries.

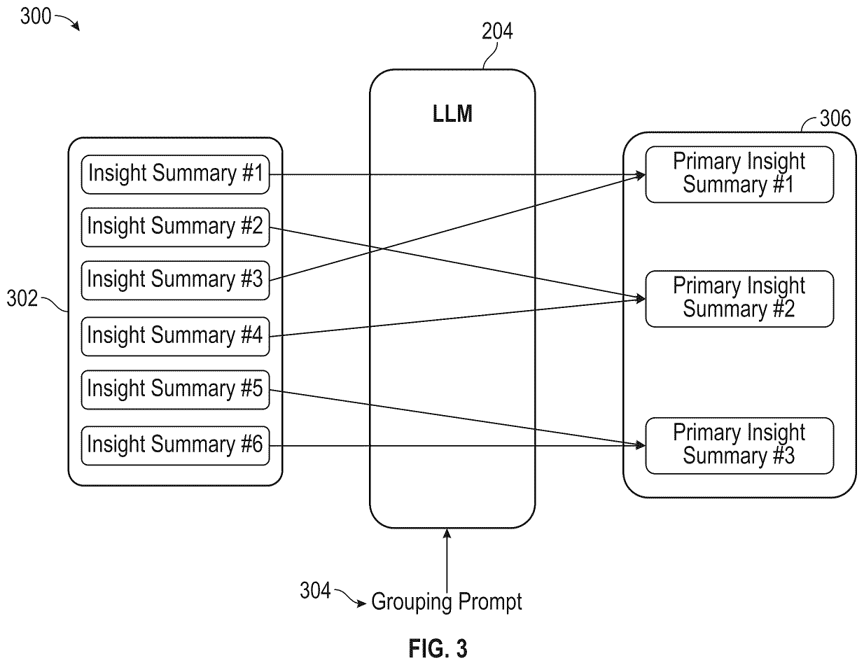

FIG. 3 illustrates a block diagram 300 of the operations of the primary grouping layer 110. The insight summaries 302 of the same type are provided to the LLM 204 with a grouping prompt 304 to collate and group similar insight summaries amongst the insight summaries 302 and to generate primary insight summaries 306 for each group. The insight summaries 302 are obtained from the insight extraction stage 108. The insight summaries 302 are of the same type. For example, they can be “feature request” insight summaries obtained from the insight summary results 212 from the operations of diagram 200. In another run of the LLM 204 a different type of insight summary, for example “complaints” insight summaries can be grouped. By maintaining the same type of insight in each run of the LLM 204, the likelihood of LLM hallucination is reduced. The grouping prompt 304 contains LLM instructions to collate and group similar insight summaries, to generate a primary insight summary for each group and to record a source of the output. The source of the output in the primary grouping layer operations 110 includes recording the identifiers of the insight summaries 302 from which a primary insight summary 306 was generated. Furthermore, the primary insight summaries are distinct and unique, relative to one another.

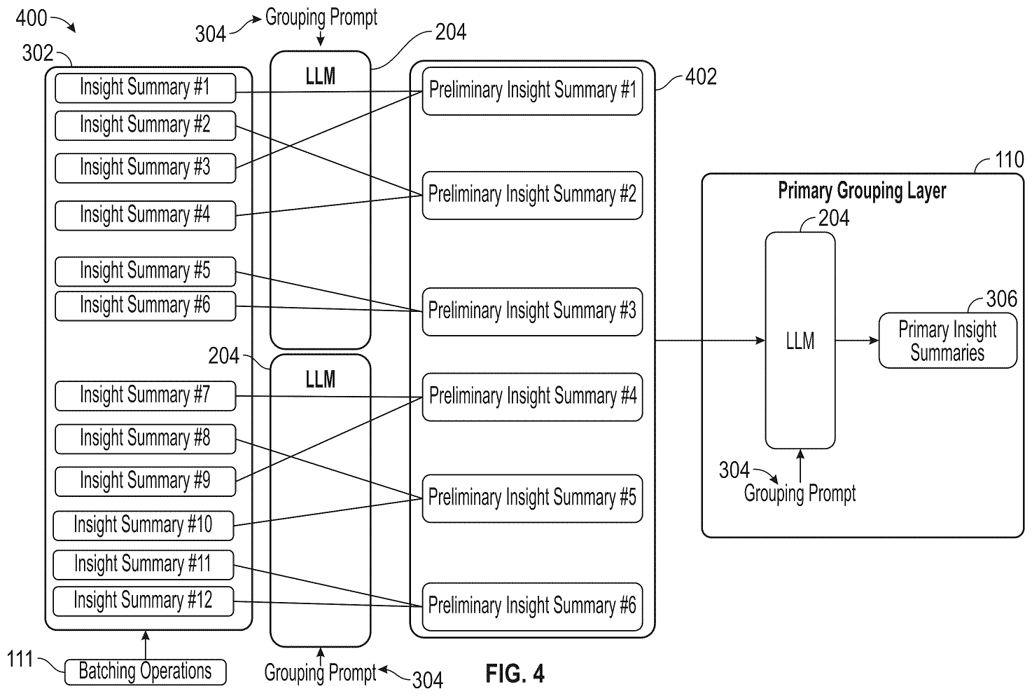

FIG. 4 illustrates a diagram 400 of the operations of the preliminary grouping layer or layers 112 when the insight summaries 302 exceed the LLM input size threshold. Batching operations 111 divide the insight summaries 302 into batches, which are each smaller or equal in size (number) to the LLM input size threshold. Each batch is processed in the LLM 204 with the same grouping prompt 204, with an instruction to the LLM to find and group similar insight summaries, generate a preliminary insight summary 402 of each group and record an identifier of the insight summaries from which the preliminary insight summary 402 was generated. In the example shown, the insight summaries 302 were divided into two batches and processed with the same grouping prompt 304, generating the preliminary insight summaries 402. In the example shown, the preliminary insight summaries 402 are smaller in size than the LLM input size threshold and can be processed by the primary grouping layer 110, with the same grouping prompt 304, to generate the primary insight summaries 304. In the example shown, one layer of batching and preliminary grouping layer reduced the size of the input to the primary grouping layer below the LLM input size threshold. In scenarios where the preliminary insight summaries 402 still exceed the LLM input size threshold, batching and additional grouping layers can be applied, where each batch is processed in the LLM with the same grouping prompt 304, until the number of preliminary insight summaries 402 are reduced below the LLM input size threshold. Preliminary grouping layers can alternatively be referred to as intermediary grouping layers, for example when more than one grouping layers are applied to reduce the size of the insight summaries below the LLM input size threshold.

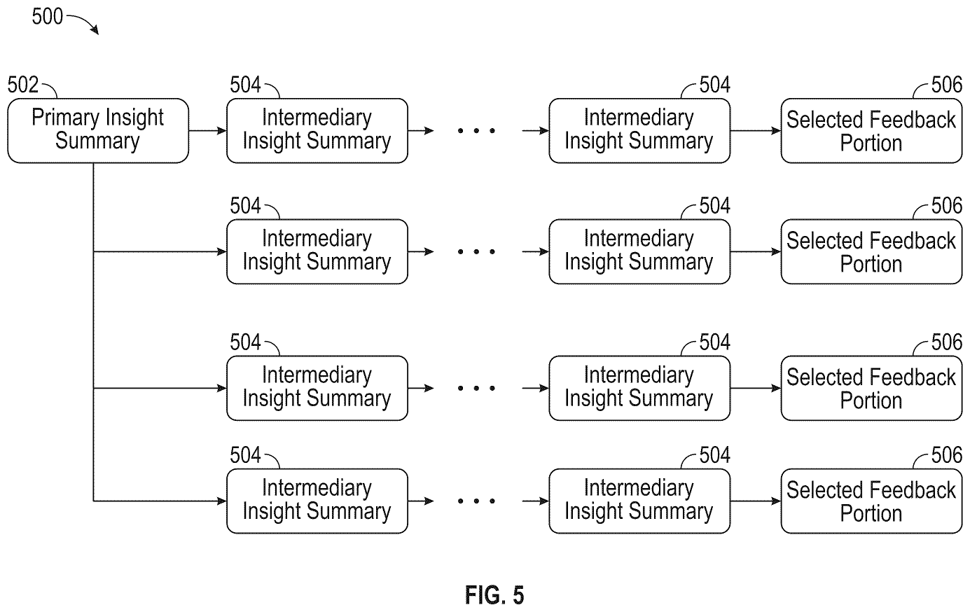

FIG. 5 illustrates a diagram 500 of the mapping stage 114. A primary insight summary 502 can be traced through intermediary insight summaries 504 and to the selected feedback portions 506, from which the chains of the insight summaries were generated. Some or all of the data in the chains between primary insight summary 502 and the selected feedback portions 506 can be presented in one or more user interface elements to a user of the pipeline 100.

### Example Implementation Mechanism—Hardware Overview

Some embodiments are implemented by a computer system or a network of computer systems. A computer system may include a processor, a memory, and a non-transitory computer-readable medium. The memory and non-transitory medium may store instructions for performing methods, steps and techniques described herein.

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be server computers, cloud computing computers, desktop computer systems, portable computer systems, handheld devices, networking devices or any other device that incorporates hard-wired and/or program logic to implement the techniques.

For example, FIG. 10 is a block diagram that illustrates a computer system 1000 upon which an embodiment of can be implemented. Computer system 1000 includes a bus 1002 or other communication mechanism for communicating information, and a hardware processor 1004 coupled with bus 1002 for processing information. Hardware processor 1004 may be, for example, special-purpose microprocessor optimized for handling audio and video streams generated, transmitted or received in video conferencing architectures.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid state disk is provided and coupled to bus 1002 for storing information and instructions.

Computer system 1000 may be coupled via bus 1002 to a display 1012, such as a cathode ray tube (CRT), liquid crystal display (LCD), organic light-emitting diode (OLED), or a touchscreen for displaying information to a computer user. An input device 1014, including alphanumeric and other keys (e.g., in a touch screen display) is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane. In some embodiments, the user input device 1014 and/or the cursor control 1016 can be implemented in the display 1012 for example, via a touch-screen interface that serves as both output display and input device.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical, magnetic, and/or solid-state disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018. The received code may be executed by processor 1004 as it is received, and/or stored in storage device 1010, or other non-volatile storage for later execution.

In some embodiments, one or more AI models can be implemented in one or more application integrated circuits for an artificial intelligence such as an artificial neural network (ANN). Such integrated circuits can represent a plurality of neurons organized in an array, where each neuron includes a register, a microprocessor, and each neuron receives at least one input. The integrated circuits can further represent a plurality of synaptic circuits, each synaptic circuit including a memory for storing a synaptic weight, where each neuron is connected to at least one other neuron via one of the plurality of the synaptic circuits.

Weights in a neural network are values that determine the importance of the input signals that a neuron receives. Weights are learnable parameters of the neural network. When a neuron receives an input signal, the input signal is multiplied by the weight associated with that input signal and provided to the neuron's processing element. The processing element sums all the weighted input signals that the neuron receives to determine the neuron's net input.

An activation function is applied to this net input to produce the neuron's output. The activation function introduces non-linearity into the network, allowing it to learn complex patterns and relationships within the data. Common activation functions include the sigmoid function, which maps the input to a value between 0 and 1, the hyperbolic tangent function, which maps the input to a value between −1 and 1, and the rectified linear unit (ReLU), which outputs the input directly if it is positive, otherwise it outputs zero.

The combination of weights and activation functions allows neural networks to approximate complex functions and make predictions or classifications based on input data. During training, the network adjusts the weights through a process called backpropagation, which involves calculating the gradient of the loss function with respect to each weight and updating the weights in the direction that minimizes the loss. This process is repeated iteratively until the network achieves a satisfactory level of accuracy. It is also possible to use a self-organizing neural network such as a Boltzman machine or an autoencoder.

In a hardware implementation of the described embodiments, one or more of the AI models can be executable on one or more processors, or microprocessors coupled to memory devices. The memory devices can store the executable instructions, related to the AI models. The stored executable instructions can program the processors or microprocessors to generate a plurality of neurons organized in an array in the memory devices. Each neuron can be implemented in the hardware to include or be connected to a register implemented in the processing elements, and to receive at least one neuron input. Each neuron can also be connected to a plurality of synaptic circuits, where each synaptic circuit, in turn includes additional neurons implemented in a synaptic memory for storing a synaptic weight, and an activation function. Each neuron is connected to at least one other neuron via one of the plurality of synaptic circuits. The execution of the AI models can include adjusting the synaptic weights, and executing the activation functions in a plurality of executions or runs of the AI models to generate an output.

### EXAMPLES

It will be appreciated that the present disclosure may include any one and up to all of the following examples.

Example 1: A method comprising: receiving a list of insight types; receiving feedback data; selecting a portion of the feedback data; for an insight type, inputting the selected portion of the feedback data to a large language model (LLM); issuing an insight extraction prompt to the LLM, the insight extraction prompt comprising LLM instructions to determine whether the selected portion of the feedback data, contextually matches the insight type, the insight extraction prompt further comprising LLM instructions to generate an insight summary of the matched insight type from the selected portion of the feedback data; repeating the issuing the insight extraction prompt for additional selections of the feedback data, gathering additional insight summaries of the insight type; issuing a grouping prompt to the LLM, the grouping prompt comprising LLM instructions to group similar insight summaries, and to generate a primary insight summary for each group, wherein the LLM comprises at least one artificial intelligence (AI) model, executable on one or more processors, coupled to a memory, programmed with executable instructions, to store in the memory, a plurality of neurons organized in an array, wherein each neuron comprises a register, a processing element, and at least one neuron input, and a plurality of synaptic circuits, each synaptic circuit including a synaptic memory for storing a synaptic weight, wherein each neuron is connected to at least one other neuron via one of the plurality of synaptic circuits, wherein the AI model adjusts the synaptic weights, in a plurality of executions or runs of the AI model to generate an output.

Example 2: The method of Example 1 further comprising: when a number of insight summaries of a type exceeds a selected LLM input size threshold, performing preliminary grouping by: batching the insight summaries into batches smaller in size than the LLM input size threshold, process each batch in the LLM with the grouping prompt, generating preliminary insight summaries; providing the preliminary insight summaries to the LLM as input; and issuing the grouping prompt to the LLM, instructing the LLM to group similar preliminary insight summaries, and to generate the primary insight summaries for each group of similar preliminary insight summaries.

Example 3: The method of any of Examples 1 and 2, further comprising: when a number of insight summaries of a type exceeds a selected LLM input size threshold, performing one or more preliminary groupings by: batching the insight summaries into batches smaller in size than the LLM input size threshold; processing each batch in the LLM with the grouping prompt generating preliminary insights, wherein when the preliminary insights exceed the selected LLM input size threshold, further batching the preliminary insight summaries in batches smaller in size than the LLM input size threshold; processing the preliminary insight batches in one or more additional LLM processing layers, each LLM processing layer instructed with the grouping prompt, wherein each layer progressively reduces the size of the preliminary insight summaries until the preliminary insight summaries reach a size lower than the LLM input size threshold; and processing the reduced preliminary insight summaries in the LLM with the grouping prompt, generating the primary insight summaries.

Example 4: The method of any of Examples 1-3, wherein the insight extraction prompt further comprises an LLM instruction to generate the insight summaries with a recitation of an identifier of a location in the portion of the feedback data corresponding to the generated insight summary.

Example 5: The method of any of Examples 1-4, wherein the grouping prompt further comprises an LLM instruction to generate the primary insight summaries with a recitation of the insight summaries corresponding to and used to generate each primary insight summary.

Example 6: The method of any of Examples 1-5, further comprising: instructing the LLM in the insight extraction prompt, to recite an identifier of a location in the portion of the feedback data, corresponding to and used for generating the insight summaries; when the insight summaries exceed an LLM input size threshold, batching the insight summaries in batches smaller in size than the LLM input size threshold; processing each batch in the one or more LLM processing layers, wherein the LLM in each layer is instructed with the grouping prompt, and the one or more LLM processing layers generate preliminary insight summaries, progressively reducing the size of the preliminary insight summaries, until the preliminary insight summaries reach a size below the LLM input size threshold, wherein the grouping prompt comprises an LLM instruction to generate insight summaries, preliminary insight summaries and the primary insight summaries with an identifier of a source corresponding to and used to generate an output insight summary of each layer; and generating a user interface comprising a table of primary insight summaries, wherein the user interface element, using the identifiers of the sources, comprises a depiction of a chain from a primary insight summary to portions of the feedback data, corresponding to and used to generate the primary insight summaries.

Example 7: The method of any of Examples 1-6, wherein the insight extraction prompt and the grouping prompt comprises LLM instructions to record a source of an output of the LLM; and the method further comprises: detecting LLM hallucination, by evaluating an output of the LLM with an LLM-stated source, relative to a prompt under which the LLM generated the output.

Example 8: A non-transitory computer storage medium that stores executable program instructions that, when executed by one or more computing devices, configure the one or more computing devices to perform operations comprising: receiving a list of insight types; receiving feedback data; selecting a portion of the feedback data; for an insight type, inputting the selected portion of the feedback data to a large language model (LLM); issuing an insight extraction prompt to the LLM, the insight extraction prompt comprising LLM instructions to determine whether the selected portion of the feedback data, contextually matches the insight type, the insight extraction prompt further comprising LLM instructions to generate an insight summary of the matched insight type from the selected portion of the feedback data; repeating the issuing the insight extraction prompt for additional selections of the feedback data, gathering additional insight summaries of the insight type; issuing a grouping prompt to the LLM, the grouping prompt comprising LLM instructions to group similar insight summaries, and to generate a primary insight summary for each group, wherein the LLM comprises at least one artificial intelligence (AI) model, executable on one or more processors, coupled to a memory, programmed with executable instructions, to store in the memory, a plurality of neurons organized in an array, wherein each neuron comprises a register, a processing element, and at least one neuron input, and a plurality of synaptic circuits, each synaptic circuit including a synaptic memory for storing a synaptic weight, wherein each neuron is connected to at least one other neuron via one of the plurality of synaptic circuits, wherein the AI model adjusts the synaptic weights, in a plurality of executions or runs of the AI model to generate an output.

Example 9: The non-transitory computer storage of Example 8, wherein the operations further comprise: when a number of insight summaries of a type exceeds a selected LLM input size threshold, performing preliminary grouping by: batching the insight summaries into batches smaller in size than the LLM input size threshold, process each batch in the LLM with the grouping prompt, generating preliminary insight summaries; providing the preliminary insight summaries to the LLM as input; and issuing the grouping prompt to the LLM, instructing the LLM to group similar preliminary insight summaries, and to generate the primary insight summaries for each group of similar preliminary insight summaries.

Example 10: The non-transitory computer storage of any of Examples 8 and 9, wherein the operations further comprise: when a number of insight summaries of a type exceeds a selected LLM input size threshold, performing one or more preliminary groupings by: batching the insight summaries into batches smaller in size than the LLM input size threshold; processing each batch in the LLM with the grouping prompt generating preliminary insights, wherein when the preliminary insights exceed the selected LLM input size threshold, further batching the preliminary insight summaries in batches smaller in size than the LLM input size threshold; processing the preliminary insight batches in one or more additional LLM processing layers, each LLM processing layer instructed with the grouping prompt, wherein each layer progressively reduces the size of the preliminary insight summaries until the preliminary insight summaries reach a size lower than the LLM input size threshold; and processing the reduced preliminary insight summaries in the LLM with the grouping prompt, generating the primary insight summaries.

Example 11: The non-transitory computer storage of any of Examples 8-10, wherein the insight extraction prompt further comprises an LLM instruction to generate the insight summaries with a recitation of an identifier of a location in the portion of the feedback data corresponding to the generated insight summary.

Example 12: The non-transitory computer storage of any of Examples 8-11, wherein the grouping prompt further comprises an LLM instruction to generate the primary insight summaries with a recitation of the insight summaries corresponding to and used to generate each primary insight summary.

Example 13: The non-transitory computer storage of any of Examples 8-12, wherein the operations further comprise: instructing the LLM in the insight extraction prompt, to recite an identifier of a location in the portion of the feedback data, corresponding to and used for generating the insight summaries; when the insight summaries exceed an LLM input size threshold, batching the insight summaries in batches smaller in size than the LLM input size threshold; processing each batch in the one or more LLM processing layers, wherein the LLM in each layer is instructed with the grouping prompt, and the one or more LLM processing layers generate preliminary insight summaries, progressively reducing the size of the preliminary insight summaries, until the preliminary insight summaries reach a size below the LLM input size threshold, wherein the grouping prompt comprises an LLM instruction to generate insight summaries, preliminary insight summaries and the primary insight summaries with an identifier of a source corresponding to and used to generate an output insight summary of each layer; and generating a user interface comprising a table of primary insight summaries, wherein the user interface element, using the identifiers of the sources, comprises a depiction of a chain from a primary insight summary to portions of the feedback data, corresponding to and used to generate the primary insight summaries.

Example 14: The non-transitory computer storage of any of Examples 8-13, wherein the insight extraction prompt and the grouping prompt comprises LLM instructions to record a source of an output of the LLM; and the operations further comprise: detecting LLM hallucination, by evaluating an output of the LLM with an LLM-stated source, relative to a prompt under which the LLM generated the output.

Example 15: A system comprising one or more processors, wherein the one or more processors are configured to perform operations comprising: receiving a list of insight types; receiving feedback data; selecting a portion of the feedback data; for an insight type, inputting the selected portion of the feedback data to a large language model (LLM); issuing an insight extraction prompt to the LLM, the insight extraction prompt comprising LLM instructions to determine whether the selected portion of the feedback data, contextually matches the insight type, the insight extraction prompt further comprising LLM instructions to generate an insight summary of the matched insight type from the selected portion of the feedback data; repeating the issuing the insight extraction prompt for additional selections of the feedback data, gathering additional insight summaries of the insight type; issuing a grouping prompt to the LLM, the grouping prompt comprising LLM instructions to group similar insight summaries, and to generate a primary insight summary for each group, wherein the LLM comprises at least one artificial intelligence (AI) model, executable on one or more processors, coupled to a memory, programmed with executable instructions, to store in the memory, a plurality of neurons organized in an array, wherein each neuron comprises a register, a processing element, and at least one neuron input, and a plurality of synaptic circuits, each synaptic circuit including a synaptic memory for storing a synaptic weight, wherein each neuron is connected to at least one other neuron via one of the plurality of synaptic circuits, wherein the AI model adjusts the synaptic weights, in a plurality of executions or runs of the AI model to generate an output.

Example 16: The system of Example 15, wherein the operations further comprise: when a number of insight summaries of a type exceeds a selected LLM input size threshold, performing preliminary grouping by: batching the insight summaries into batches smaller in size than the LLM input size threshold, process each batch in the LLM with the grouping prompt, generating preliminary insight summaries; providing the preliminary insight summaries to the LLM as input; and issuing the grouping prompt to the LLM, instructing the LLM to group similar preliminary insight summaries, and to generate the primary insight summaries for each group of similar preliminary insight summaries.

Example 17: The system of any of Examples 15 and 16, wherein the operations further comprise: when a number of insight summaries of a type exceeds a selected LLM input size threshold, performing one or more preliminary groupings by: batching the insight summaries into batches smaller in size than the LLM input size threshold; processing each batch in the LLM with the grouping prompt generating preliminary insights, wherein when the preliminary insights exceed the selected LLM input size threshold, further batching the preliminary insight summaries in batches smaller in size than the LLM input size threshold; processing the preliminary insight batches in one or more additional LLM processing layers, each LLM processing layer instructed with the grouping prompt, wherein each layer progressively reduces the size of the preliminary insight summaries until the preliminary insight summaries reach a size lower than the LLM input size threshold; and processing the reduced preliminary insight summaries in the LLM with the grouping prompt, generating the primary insight summaries.

Example 18: The system of any of Examples 15-17, wherein the insight extraction prompt further comprises an LLM instruction to generate the insight summaries with a recitation of an identifier of a location in the portion of the feedback data corresponding to the generated insight summary.

Example 19: The system of any of Examples 15-18, wherein the grouping prompt further comprises an LLM instruction to generate the primary insight summaries with a recitation of the insight summaries corresponding to and used to generate each primary insight summary.

Example 20: The system of any of Examples 15-19, wherein the operations further comprise: instructing the LLM in the insight extraction prompt, to recite an identifier of a location in the portion of the feedback data, corresponding to and used for generating the insight summaries; when the insight summaries exceed an LLM input size threshold, batching the insight summaries in batches smaller in size than the LLM input size threshold; processing each batch in the one or more LLM processing layers, wherein the LLM in each layer is instructed with the grouping prompt, and the one or more LLM processing layers generate preliminary insight summaries, progressively reducing the size of the preliminary insight summaries, until the preliminary insight summaries reach a size below the LLM input size threshold, wherein the grouping prompt comprises an LLM instruction to generate insight summaries, preliminary insight summaries and the primary insight summaries with an identifier of a source corresponding to and used to generate an output insight summary of each layer; and generating a user interface comprising a table of primary insight summaries, wherein the user interface element, using the identifiers of the sources, comprises a depiction of a chain from a primary insight summary to portions of the feedback data, corresponding to and used to generate the primary insight summaries.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including, hard drives, floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects.

What is claimed is:

1. A method comprising:
receiving a list of insight types;
receiving feedback data;
selecting a portion of the feedback data;
for an insight type, inputting the selected portion of the feedback data to a large language model (LLM);
issuing an insight extraction prompt to the LLM, the insight extraction prompt comprising LLM instructions to determine whether the selected portion of the feedback data, contextually matches the insight type, the insight extraction prompt further comprising LLM instructions to generate an insight summary of the matched insight type from the selected portion of the feedback data;
repeating the issuing the insight extraction prompt for additional selections of the feedback data, gathering additional insight summaries of the insight type;
issuing a grouping prompt to the LLM, the grouping prompt comprising LLM instructions to group similar insight summaries, and to generate a primary insight summary for each group,
wherein the LLM comprises at least one artificial intelligence (AI) model, executable on one or more processors, coupled to a memory, programmed with executable instructions, to store in the memory, a plurality of neurons organized in an array, wherein each neuron comprises a register, a processing element, and at least one neuron input, and a plurality of synaptic circuits, each synaptic circuit including a synaptic memory for storing a synaptic weight, wherein each neuron is connected to at least one other neuron via one of the plurality of synaptic circuits, wherein the AI model adjusts the synaptic weights, in a plurality of executions or runs of the AI model to generate an output.

2. The method of claim 1 further comprising:
when a number of insight summaries of a type exceeds a selected LLM input size threshold, performing preliminary grouping by:
batching the insight summaries into batches smaller in size than the LLM input size threshold,
process each batch in the LLM with the grouping prompt, generating preliminary insight summaries;
providing the preliminary insight summaries to the LLM as input; and
issuing the grouping prompt to the LLM, instructing the LLM to group similar preliminary insight summaries, and to generate the primary insight summaries for each group of similar preliminary insight summaries.

3. The method of claim 1 further comprising:
when a number of insight summaries of a type exceeds a selected LLM input size threshold, performing one or more preliminary groupings by:
batching the insight summaries into batches smaller in size than the LLM input size threshold;
processing each batch in the LLM with the grouping prompt generating preliminary insights,
wherein when the preliminary insights exceed the selected LLM input size threshold, further batching the preliminary insight summaries in batches smaller in size than the LLM input size threshold; processing the preliminary insight batches in one or more additional LLM processing layers, each LLM processing layer instructed with the grouping prompt, wherein each layer progressively reduces the size of the preliminary insight summaries until the preliminary insight summaries reach a size lower than the LLM input size threshold; and
processing the reduced preliminary insight summaries in the LLM with the grouping prompt, generating the primary insight summaries.

4. The method of claim 1, wherein the insight extraction prompt further comprises an LLM instruction to generate the insight summaries with a recitation of an identifier of a location in the portion of the feedback data corresponding to the generated insight summary.

5. The method of claim 1, wherein the grouping prompt further comprises an LLM instruction to generate the primary insight summaries with a recitation of the insight summaries corresponding to and used to generate each primary insight summary.

6. The method of claim 1, further comprising:
instructing the LLM in the insight extraction prompt, to recite an identifier of a location in the portion of the feedback data, corresponding to and used for generating the insight summaries;
when the insight summaries exceed an LLM input size threshold, batching the insight summaries in batches smaller in size than the LLM input size threshold;
processing each batch in the one or more LLM processing layers, wherein the LLM in each layer is instructed with the grouping prompt, and the one or more LLM processing layers generate preliminary insight summaries, progressively reducing the size of the preliminary insight summaries, until the preliminary insight summaries reach a size below the LLM input size threshold,
wherein the grouping prompt comprises an LLM instruction to generate insight summaries, preliminary insight summaries and the primary insight summaries with an identifier of a source corresponding to and used to generate an output insight summary of each layer; and
generating a user interface comprising a table of primary insight summaries, wherein the user interface element, using the identifiers of the sources, comprises a depiction of a chain from a primary insight summary to portions of the feedback data, corresponding to and used to generate the primary insight summaries.

7. The method of claim 1, wherein the insight extraction prompt and the grouping prompt comprises LLM instructions to record a source of an output of the LLM; and the method further comprises:
detecting LLM hallucination, by evaluating an output of the LLM with an LLM-stated source, relative to a prompt under which the LLM generated the output.

8. A non-transitory computer storage medium that stores executable program instructions that, when executed by one or more computing devices, configure the one or more computing devices to perform operations comprising:
receiving a list of insight types;
receiving feedback data;
selecting a portion of the feedback data;
for an insight type, inputting the selected portion of the feedback data to a large language model (LLM);
issuing an insight extraction prompt to the LLM, the insight extraction prompt comprising LLM instructions to determine whether the selected portion of the feedback data, contextually matches the insight type, the insight extraction prompt further comprising LLM instructions to generate an insight summary of the matched insight type from the selected portion of the feedback data;
repeating the issuing the insight extraction prompt for additional selections of the feedback data, gathering additional insight summaries of the insight type;
issuing a grouping prompt to the LLM, the grouping prompt comprising LLM instructions to group similar insight summaries, and to generate a primary insight summary for each group,
wherein the LLM comprises at least one artificial intelligence (AI) model, executable on one or more processors, coupled to a memory, programmed with executable instructions, to store in the memory, a plurality of neurons organized in an array, wherein each neuron comprises a register, a processing element, and at least one neuron input, and a plurality of synaptic circuits, each synaptic circuit including a synaptic memory for storing a synaptic weight, wherein each neuron is connected to at least one other neuron via one of the plurality of synaptic circuits, wherein the AI model adjusts the synaptic weights, in a plurality of executions or runs of the AI model to generate an output.

9. The non-transitory computer storage of claim 8, wherein the operations further comprise:
when a number of insight summaries of a type exceeds a selected LLM input size threshold, performing preliminary grouping by:
batching the insight summaries into batches smaller in size than the LLM input size threshold,
process each batch in the LLM with the grouping prompt, generating preliminary insight summaries;
providing the preliminary insight summaries to the LLM as input; and
issuing the grouping prompt to the LLM, instructing the LLM to group similar preliminary insight summaries, and to generate the primary insight summaries for each group of similar preliminary insight summaries.

10. The non-transitory computer storage of claim 8, wherein the operations further comprise:
when a number of insight summaries of a type exceeds a selected LLM input size threshold, performing one or more preliminary groupings by:
batching the insight summaries into batches smaller in size than the LLM input size threshold;
processing each batch in the LLM with the grouping prompt generating preliminary insights,
wherein when the preliminary insights exceed the selected LLM input size threshold, further batching the preliminary insight summaries in batches smaller in size than the LLM input size threshold; processing the preliminary insight batches in one or more additional LLM processing layers, each LLM processing layer instructed with the grouping prompt, wherein each layer progressively reduces the size of the preliminary insight summaries until the preliminary insight summaries reach a size lower than the LLM input size threshold; and
processing the reduced preliminary insight summaries in the LLM with the grouping prompt, generating the primary insight summaries.

11. The non-transitory computer storage of claim 8, wherein the insight extraction prompt further comprises an LLM instruction to generate the insight summaries with a recitation of an identifier of a location in the portion of the feedback data corresponding to the generated insight summary.

12. The non-transitory computer storage of claim 8, wherein the grouping prompt further comprises an LLM instruction to generate the primary insight summaries with a recitation of the insight summaries corresponding to and used to generate each primary insight summary.

13. The non-transitory computer storage of claim 8, wherein the operations further comprise:
instructing the LLM in the insight extraction prompt, to recite an identifier of a location in the portion of the feedback data, corresponding to and used for generating the insight summaries;
when the insight summaries exceed an LLM input size threshold, batching the insight summaries in batches smaller in size than the LLM input size threshold;
processing each batch in the one or more LLM processing layers, wherein the LLM in each layer is instructed with the grouping prompt, and the one or more LLM processing layers generate preliminary insight summaries, progressively reducing the size of the preliminary insight summaries, until the preliminary insight summaries reach a size below the LLM input size threshold,
wherein the grouping prompt comprises an LLM instruction to generate insight summaries, preliminary insight summaries and the primary insight summaries with an identifier of a source corresponding to and used to generate an output insight summary of each layer; and
generating a user interface comprising a table of primary insight summaries, wherein the user interface element, using the identifiers of the sources, comprises a depiction of a chain from a primary insight summary to portions of the feedback data, corresponding to and used to generate the primary insight summaries.

14. The non-transitory computer storage of claim 8, wherein the insight extraction prompt and the grouping prompt comprises LLM instructions to record a source of an output of the LLM; and the operations further comprise:
detecting LLM hallucination, by evaluating an output of the LLM with an LLM-stated source, relative to a prompt under which the LLM generated the output.

15. A system comprising one or more processors, wherein the one or more processors are configured to perform operations comprising:
receiving a list of insight types;
receiving feedback data;
selecting a portion of the feedback data;
for an insight type, inputting the selected portion of the feedback data to a large language model (LLM);
issuing an insight extraction prompt to the LLM, the insight extraction prompt comprising LLM instructions to determine whether the selected portion of the feedback data, contextually matches the insight type, the insight extraction prompt further comprising LLM instructions to generate an insight summary of the matched insight type from the selected portion of the feedback data;
repeating the issuing the insight extraction prompt for additional selections of the feedback data, gathering additional insight summaries of the insight type;
issuing a grouping prompt to the LLM, the grouping prompt comprising LLM instructions to group similar insight summaries, and to generate a primary insight summary for each group,
wherein the LLM comprises at least one artificial intelligence (AI) model, executable on one or more processors, coupled to a memory, programmed with executable instructions, to store in the memory, a plurality of neurons organized in an array, wherein each neuron comprises a register, a processing element, and at least one neuron input, and a plurality of synaptic circuits, each synaptic circuit including a synaptic memory for storing a synaptic weight, wherein each neuron is connected to at least one other neuron via one of the plurality of synaptic circuits, wherein the AI model adjusts the synaptic weights, in a plurality of executions or runs of the AI model to generate an output.

16. The system of claim 15, wherein the operations further comprise:
when a number of insight summaries of a type exceeds a selected LLM input size threshold, performing preliminary grouping by:
batching the insight summaries into batches smaller in size than the LLM input size threshold,
process each batch in the LLM with the grouping prompt, generating preliminary insight summaries;
providing the preliminary insight summaries to the LLM as input; and
issuing the grouping prompt to the LLM, instructing the LLM to group similar preliminary insight summaries, and to generate the primary insight summaries for each group of similar preliminary insight summaries.

17. The system of claim 15, wherein the operations further comprise:
when a number of insight summaries of a type exceeds a selected LLM input size threshold, performing one or more preliminary groupings by:
batching the insight summaries into batches smaller in size than the LLM input size threshold;
processing each batch in the LLM with the grouping prompt generating preliminary insights,
wherein when the preliminary insights exceed the selected LLM input size threshold, further batching the preliminary insight summaries in batches smaller in size than the LLM input size threshold; processing the preliminary insight batches in one or more additional LLM processing layers, each LLM processing layer instructed with the grouping prompt, wherein each layer progressively reduces the size of the preliminary insight summaries until the preliminary insight summaries reach a size lower than the LLM input size threshold; and
processing the reduced preliminary insight summaries in the LLM with the grouping prompt, generating the primary insight summaries.

18. The system of claim 15, wherein the insight extraction prompt further comprises an LLM instruction to generate the insight summaries with a recitation of an identifier of a location in the portion of the feedback data corresponding to the generated insight summary.

19. The system of claim 15, wherein the grouping prompt further comprises an LLM instruction to generate the primary insight summaries with a recitation of the insight summaries corresponding to and used to generate each primary insight summary.

20. The system of claim 15, wherein the operations further comprise:
instructing the LLM in the insight extraction prompt, to recite an identifier of a location in the portion of the feedback data, corresponding to and used for generating the insight summaries;
when the insight summaries exceed an LLM input size threshold, batching the insight summaries in batches smaller in size than the LLM input size threshold;
processing each batch in the one or more LLM processing layers, wherein the LLM in each layer is instructed with the grouping prompt, and the one or more LLM processing layers generate preliminary insight summaries, progressively reducing the size of the preliminary insight summaries, until the preliminary insight summaries reach a size below the LLM input size threshold,
wherein the grouping prompt comprises an LLM instruction to generate insight summaries, preliminary insight summaries and the primary insight summaries with an identifier of a source corresponding to and used to generate an output insight summary of each layer; and
generating a user interface comprising a table of primary insight summaries, wherein the user interface element, using the identifiers of the sources, comprises a depiction of a chain from a primary insight summary to portions of the feedback data, corresponding to and used to generate the primary insight summaries.
